(19) United States
(12) Patent Application Publication
(10) Pub. No.: US 2005/0124480 A1
(43) Pub. Date: Jun. 9, 2005

(54) Device for folding sheets or similar

(76) Inventor: Xavier Bibily, Cissac (FR)

Correspondence Address: Patterson Thuente;Skaar & Christensen, 2000 US Bank Center, 777 East Wisconsin Avenue, Milwaukee, WI, 53202-5345, US

(21) Appl. No.: 10/502,913

(22) PCT Filed: Jan. 31, 2003
(86) PCT No.: PCT/FR03/00312

(30) Foreign Application Priority Data
Feb. 1, 2002 (FR) 0201198

(51) Int. Cl. B31F 5/02

(52) U.S. Cl. 493/356

(57) ABSTRACT

A device for folding sheets or similar items is disclosed. The device includes a frame, a pair of plates, and a foot pedal. The pair of plates are operable to secure one end of the sheet or other item being folded in order to allow a person to properly fold the item without assistance from another person. The device also includes an immobilization mechanism for securing the frame to a wall or other structure during use.

This invention relates to a device that allows a single person to fold sheets, blankets, duvet covers, and curtains.

The problem with correctly folding a sheet is that it takes two people, one facing the other.

The two people hold the sheet by its corners and fold in widthwise in successive layers, until the desired width is achieved, and then pull on the ends of the sheet to stretch it to limit wrinkling.

Once this operation is completed, one person moves forward and gives his end of the sheet to the other.

The first person grasps the hanging end of the sheet, pulls it again, moves forward and again gives his end to the other person, and repeats the operation until the desired folding format is achieved.

The problem is that it takes two people to properly perform the folding, which does not always occur, since this operation is generally considered a chore.

The purpose of the invention is to allow a single person to properly fold sheets or similar items.

Therefore, the object of the invention is a device for folding sheets or similar items, characterized in that it consists of a frame equipped with an immobilization mechanism, consisting of:
at its upper part, a pair of plates designed to grip one end of the sheets or similar items to be folded, said pair including a fixed horizontal plate and a moveable plate mounted above the latter, hinged to the frame and able to move toward or away from said fixed plate,
and at its lower part, a pedal, hinged to the frame, connected to said moveable plate by an actuating bar, permanently returned by a spring to the movable plate's high, raised position, and equipped with a device for locking the moveable plate in a lowered position, said device being unlockable with the foot.

We will now describe in greater detail an embodiment of the device according to the invention, with reference to the attached drawings, where:

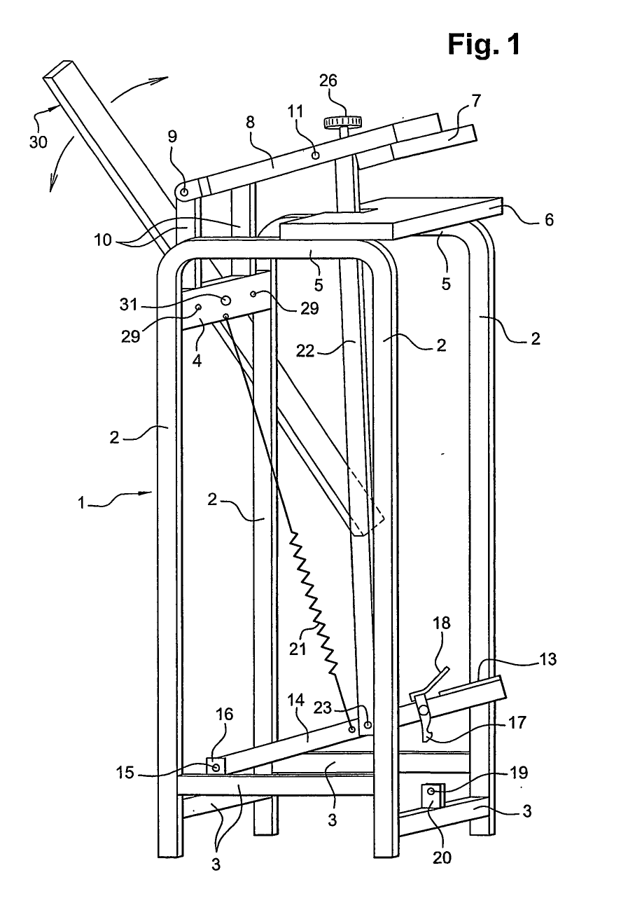

FIG. 1 is a perspective view of a device according to the invention with the movable sheet-griping plate in the raised position.

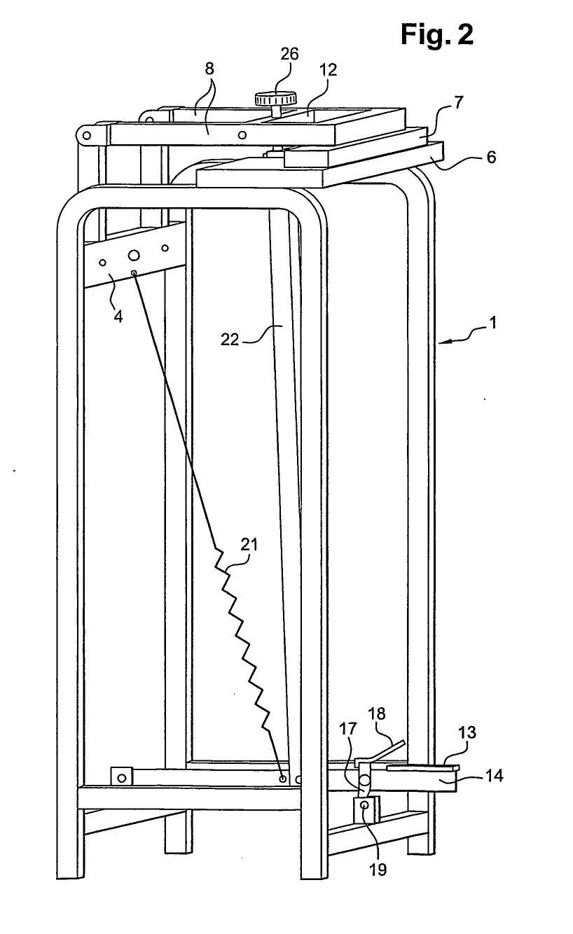

FIG. 2 illustrates the device from FIG. 1 in the sheet-griping position.

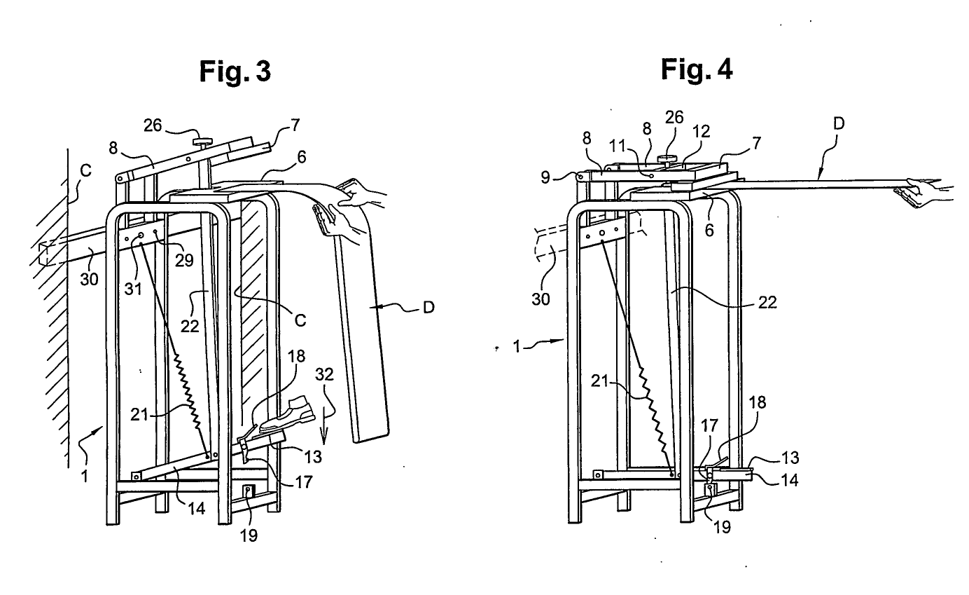

FIGS. 3 and 4 illustrate the use of the device for folding a sheet, and

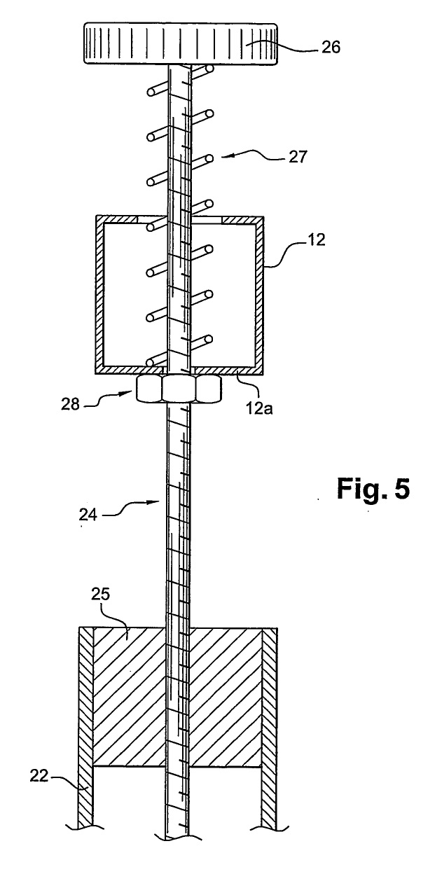

FIG. 5 is a partial cut-away view of the mechanism for adjusting the travel of the movable plate.

FIGS. 1 and 2 show a device according to the invention, consisting of a frame 1 comprising four uprights 2, interconnected at their lower part by four cross-members 3 and, at their upper part, by one rear cross-member 4 and two lateral cross-members 5. For the sake of simplicity, the uprights 2 on the same side of the frame 1 are produced from a single piece, folded in a reversed U shape, and the lateral cross-members 5 are composed of a section of said piece.

At the upper part of the frame 1, two plates are mounted, i.e., a fixed horizontal plate 6, integral with the cross-members 5 and a moveable plate 7 placed above the fixed plate 6 and hinged to the frame 1, such that it is able to able to move toward or away from the fixed plate. For that purpose, the moveable plate 7 is fixed to the end of a pair of parallel levers 8, pivoting around a horizontal axis 9 on two tabs 10 that are integral with the rear cross-member 4.

Furthermore, between the two levers 8, a cross-member, composed of a tubular piece 12, is mounted to rotate freely around a horizontal axis 11 (FIGS. 2, 4, and 5).

At its lower part, the frame 1 is equipped with a pedal 13, attached to a lever 14, pivoting around a horizontal axis 15 on a tab 16 attached to the middle of one of the cross-members 3, at the rear of the frame.

At the front of the lever 14, a hook 17, hinged to the lever and controlled by a second pedal 18, is mounted near the pedal 13. The hook 17 mates with a lug 19 on a tab 20 integral with the front cross-member 3 and attached to its middle.

A return spring (not illustrated) constantly returns the hook 17 to the locked position.

The lever 14 is constantly elastically returned to the hook 17's high remote position (as illustrated in FIG. 1) relative to the locking lug 19.

The lever 14 is elastically returned, for example, by a coil spring 21 interposed between the lever and the upper rear cross-member 4. Another return mechanism may be provided, such as a spiral spring, placed to the right of the axis 15, pulling the lever 14 upward.

Furthermore, the lever 14 controls the moveable plate 8 through the intermediary of an actuating bar 22 hinged at one end 23 to the lever 14 and connected, at its upper end, by an adjustable connecting device, illustrated in detail in FIG. 5.

This device comprises a threaded rod 24 screwed into a block 25, blocking the end of the piece making up the bar 22, and the free end of the rod 24 is equipped with an adjustment wheel 26. The rod 24 freely passes through the piece 12 and is equipped with a coil spring 27 resting, at it upper part, on the wheel 26 and, at its lower part, on the inner face of one of the walls (12a) of the piece 12.

On the opposite face of said wall 12 rests a nut 28 moveable along the rod 24 by screwing/unscrewing, such as to adjust the return force the spring 27 exerts on the piece 12.

Finally, the frame 1 is also equipped with an immobilization mechanism, composed, for example, by a set of screws or pins, engaged in the holes 29 in the rear cross-member 4 and anchored to the wall against which the frame 1 leans, or by a blocking bar 30 (FIGS. 1, 3, and 4), hinged at its center 31 to said cross-member 4.

The bar 30 can freely pivot around its horizontal axis 31 and take either a vertical (i.e., resting) position, or an approximately horizontal position (FIG. 3) when using the folding device according to the invention, as explained below.

FIGS. 1 and 2 show the folding device, respectively, in the resting position and the position where the sheets to be folded are gripped or clamped between the plates 6 and 7.

FIGS. 3 and 4 correspond to FIGS. 1 and 2 and more precisely illustrate the use of the device.

Firstly, the frame 1 is immobilized. In the example illustrated in FIG. 3, immobilization is achieved by the blocking bar 30, which is placed horizontally across the opening of a door, whose jamb is indicated by C. The ends of the bar 30 rest against the jamb C on one side of the door, such that, from the other side of the door, if the frame 1 is pulled toward you, the latter will be blocked by the jamb C, preventing the bar 30 from passing through the opening of the door.

One end of the sheet to be folded, indicated by D, is placed on the fixed plate 6, with the plate 7 raised (resting position).

The foot of the person placing the sheet D actuates the pedal 13 (arrow 32), which lowers the lever 14 until the hook 17 locks on the lug 19 (FIG. 4). At the same time, the plate 7 is lowered by the bar 22 until it grips the end of the sheet D between the two plates 6, 7.

The plate 7 grips the sheet well before the lever 14 completes its descending travel, such that the last part of the travel of the lever 14 increases the pressure exerted by the plate 7 on the sheet, due to compression of the spring 27.

When the hook 17 is locked, the person may proceed (FIG. 4) with stretching the sheet D to unwrinkle it, then with folding the sheet by placing the other end of the sheet in the plates 6, 7. To achieve this, the person presses the pedal 18 to free the hook 17, thereby causing the spring 21 to raise the bar 22 and, therefore, the plate 7.

The other end of the sheet may then be placed between the plates 6, 7, which are in the position shown in FIG. 3.

By again pressing the pedal 13, the person again brings the plates 6, 7 together, as before, and continues until the sheet is completely folded. At the end, the pedal 18 is actuated to open the plates and recover the fully folded sheet. It is possible to stretch the sheet to unwrinkle it (FIG. 4) thanks to the immobilization of the device by the bar 30.

The initial distance between the plates 6, 7 is adjusted by screwing/unscrewing the rod 24, via the wheel 26, into/out of the block 25, since the nut 28 adjusts the return force of the spring 27 on the part 12.

1. A device for folding sheets and similar items, comprising:
a frame having an upper portion and a lower portion;
a pair of plates operable to secure one end of the item to be folded, the pair comprising a fixed plate and a moveable plate mounted above the fixed plate, the moveable plate operably hinged to the upper portion of the frame to selectively move toward or away from the fixed plate; and
a foot pedal operably hinged to the frame at the lower portion and operably coupled to the moveable plate by an actuating bar, wherein the foot pedal is returned to a first raised position in mechanical communication with a raised position of the moveable plate by a spring and is equipped with a locking device for selectively locking the moveable plate in a lowered position.

2. A device according to claim 1, wherein the locking device comprises a hook operably hinged to a lever equipped with the pedal, wherein the hook selectively couples with a locking lug coupled to the lower portion of the frame to lock the moveable plate in the lowered position, and wherein the hook selectively uncouples with the locking lug via a second pedal mounted proximate the foot pedal on said lever.

3. A device according to claim 1, wherein the moveable plate is operably hinged to the upper portion of the frame by a pair of levers moveably coupled to the frame, and wherein a freely rotating cross-member is mounted between the pair of levers and is coupled to an upper end of the actuating bar.

4. A device according to claim 3, wherein the device further comprises an adjustment device for selectively adjusting a distance between the fixed plate and the moveable plate.

5. A device according to claim 4, wherein the adjustment device includes a threaded rod screwed into an aperture at the upper end of the actuating bar and selectively adjustable by a wheel, the threaded rod freely passing through the cross-member and comprising a mechanism to engage the cross-member.

6. A device according to claim 5, wherein the mechanism to engage and the cross-member comprises a nut coupled to the rod and a spring encircling the rod, the cross-member disposed between the spring and the nut.

7. A device according to claim 1, wherein the frame includes an immobilization mechanism, the immobilization mechanism comprising at least one fastener engaged in at least one hole in the frame and attached to a fixed structure.

8. A device according to claim 1, wherein the frame includes an immobilization mechanism, the immobilization mechanism comprising a blocking bar that movably rotates on the frame about a horizontal axis parallel to a direction of stretching applied to the item to be folded.
